(19) United States
(12) Patent Application Publication
(10) Pub. No.: US 2010/0180460 A1
(43) Pub. Date: Jul. 22, 2010

(54) Mop dehydrating apparatus

(76) Inventor: Jack Tang, Taipei Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/320,229

(22) Filed: Jan. 22, 2009

(51) Int. Cl. F26B 17/30

(52) U.S. Cl. 34/58

(57) ABSTRACT

A mop dehydrating apparatus includes a water tub, a dehydrating basket horizontally rotatably mounted in the internal chamber of the water tub and provided with a fixing device in the internal chamber thereof for fixing a mop, a motor drive mounted in the internal chamber of the water tub, a transmission mechanism coupled between the motor drive and the dehydrating basket and controllable by a foot pedal switch to rotate the dehydrating basket and to further expel water out of the mophead of the mop subject to the effect of centrifugal force.

### BACKGROUND OF THE INVENTION

1. Field of the Invention

The present invention relates to cleaning technology and more specifically, to a mop dehydrating apparatus for removing water from a mop.

2. Description of the Related Art

Taiwan patent number M338634, filed on Dec. 18, 2007, discloses a dehydrating apparatus, which comprises a water tub and a dehydrating basket. The dehydrating basket is horizontally rotatably mounted in the internal chamber of the water tub. A fixing device for fixing the mop is disposed in the internal chamber of the dehydrating basket. The major drawback of this structure of dehydrating apparatus is its manual driving design to dehydrate the mop by labor. Therefore, it is difficult to fully expel water from the mop, i.e., low dehydration efficiency. Further, drying the mop takes much time and labor. Further, when dehydrating the mop in the dehydrating basket, the user needs to rotate the handle of the mop with the hands. When rotating the handle of the mop, friction between the hands and the handle of the mop causes the hands to feel uncomfortable.

### SUMMARY OF THE INVENTION

The present invention has been accomplished under the circumstances in view. It is therefore the main object of the present invention to provide a mop dehydrating apparatus, which automatically expels water from the mophead of the mop, avoiding direct contact of the user's hands with the mophead.

To achieve this and other objects of the present invention, a mop dehydrating apparatus comprises a water tub, which comprises an internal chamber, and a dehydrating basket horizontally rotatably mounted in the internal chamber of the water tub. The dehydrating basket comprises an internal chamber, and fixing means for fixing a mop to the internal chamber of the dehydrating basket. The water tub has mounted in the internal chamber thereof a motor drive, which is electrically connected to power source means for rotating the dehydrating basket, a transmission means coupled between the motor drive and the dehydrating basket for enabling the motor drive to rotate said dehydrating basket, and switch means mounted in an outside recess thereof and operable to switch on/off the motor drive.

Further, the transmission means comprises a transmission gear meshed with the motor drive for rotation by the motor drive, and a transmission shaft fixedly connected between the transmission gear and the dehydrating basket for allowing rotation of the dehydrating basket in the water tub by the motor drive.

Further, the switch means is a foot pedal switch having a bottom lug supported on spring means in the outside recess.

Further, the fixing means comprises a plurality of retaining blocks provided inside the internal chamber of the dehydrating basket for engaging respective retaining grooves on a presser plate assembly of the mop.

Further, the mop comprises fibrous web elements for the retention of fluids for wet-mopping applications, a presser plate ssembly that holds the fibrous web elements, and a handle connected to the presser plate assembly.

Further, the handle comprises an upper handle element, a lower handle element, and a bearing connected between the upper handle element and the lower handle element for allowing rotation of the lower handle element relative to the upper handle element.

Further, the presser plate assembly comprises a presser plate, and two fibrous web elements clamping plates. The fibrous web elements clamping plates are fastened together and detachably connected to the presser plate by a detachable connection structure to secure the fibrous web elements. The presser plate is fixedly connected to a lower handle element of the handle.

Further, the detachable connection structure comprises a plurality of first fastening devices located on the top side of the fibrous web elements clamping plates, and a plurality of second fastening devices located on the bottom side of the presser plate for engaging the first fastening devices.

Further, the power source means comprises a rechargeable battery, and a power adapter cable electrically connectable to city power supply.

When compared to conventional techniques, the invention has the dehydrating basket be coupled to a motor drive through a transmission means. The motor drive is electrically connected to power source means subject to the control of a foot pedal switch. The invention enables a user to dry the mophead of a mop without touching the mophead with the hands. Simply by means of stepping one leg on the foot pedal switch after insertion of the mop to be dried into the dehydrating basket, water is expelled out of the mophead of the mop automatically subject to the effect of centrifugal force.

### BRIEF DESCRIPTION OF THE DRAWING

FIG. 1 is a schematic structural view of a mop dehydrating apparatus in accordance with the present invention.

FIG. 2 is an elevational view of the mop dehydrating apparatus shown in FIG 1.

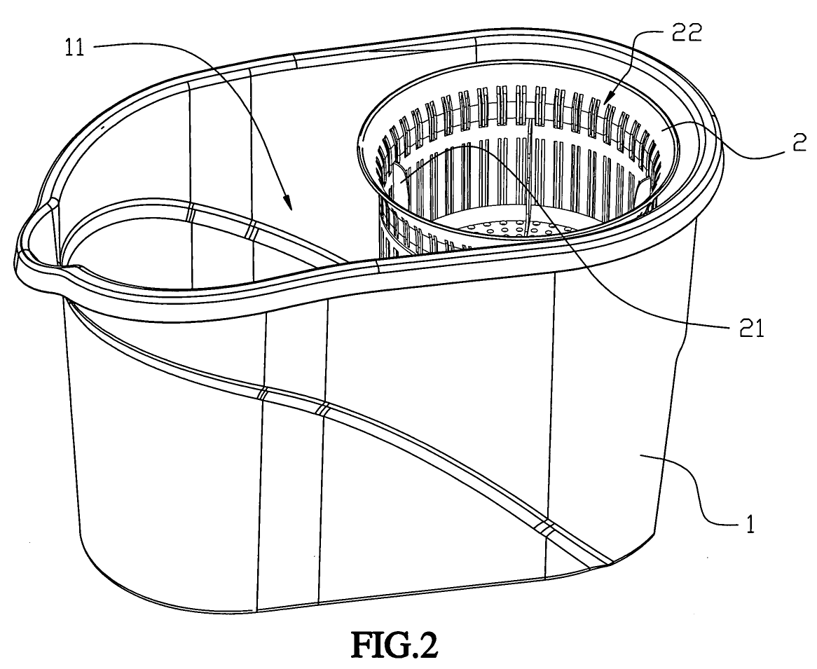

FIG. 3 is an oblique elevation of the present invention, showing a mop fixed to the mop dehydrating apparatus.

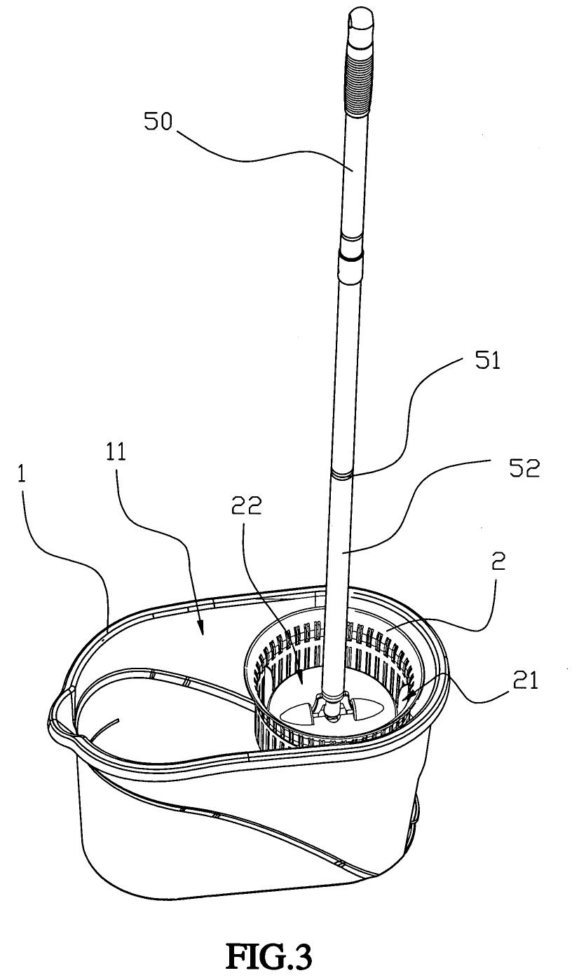

FIG. 4 is an exploded view of a part of FIG. 3.

FIG. 5 is an enlarged view of part I of FIG. 4.

### DETAILED DESCRIPTION OF THE INVENTION

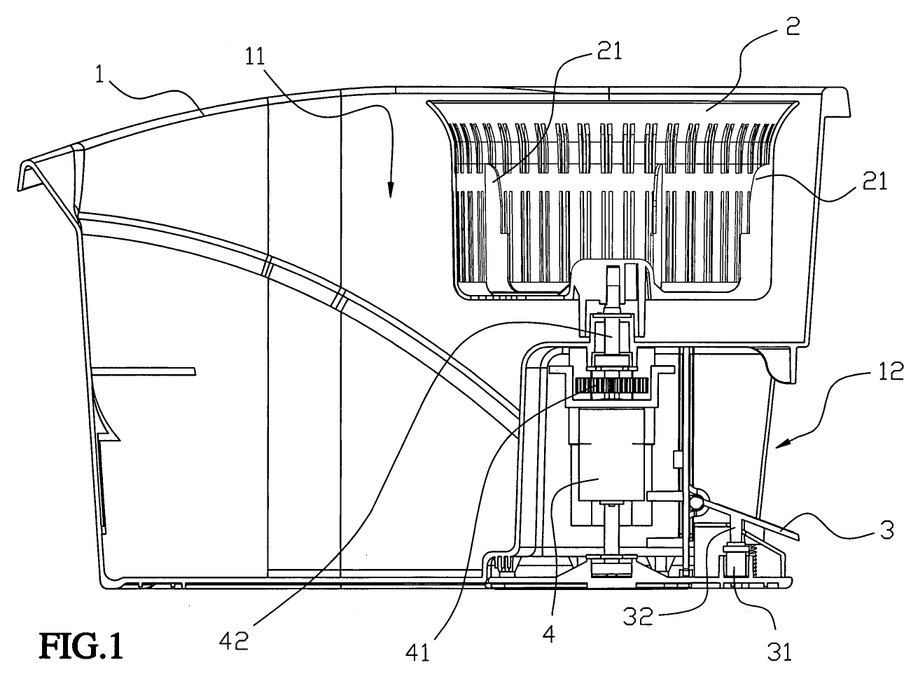

Referring to FIGS. 1˜5, a mop dehydrating apparatus in accordance with the present invention is shown comprising a water tub 1 and a dehydrating basket 2.

The dehydrating basket 2 is horizontally rotatably mounted in the internal chamber 11 in the water tub 1. Fixing means is provided in the internal chamber 22 of the dehydrating basket 2 for fixing a mop 5. The dehydrating basket 2 is coupled to a motor drive 4 through a transmission mechanism. The motor drive 4 is connected to power source. A switch 3 is mounted in a side recess 12 near the bottom side of the water tub 1. A user can operate the switch 3 to switch on/off the motor drive 4. According to the present preferred embodiment, as shown in FIG. 1, the switch 3 is a foot pedal switch, which has a bottom lug 32 supported on a spring member 31 in the side recess 12. The spring member 31 supports the switch 3 in the off position.

The aforesaid transmission mechanism comprises a transmission shaft 42 and a gear 41. The transmission shaft 42 has its top end fixedly connected to the bottom center of the dehydrating basket 2 and its bottom end fixedly connected to the center of the gear 41. The motor drive 4 is meshed with the gear 41 for rotating the dehydrating basket 2.

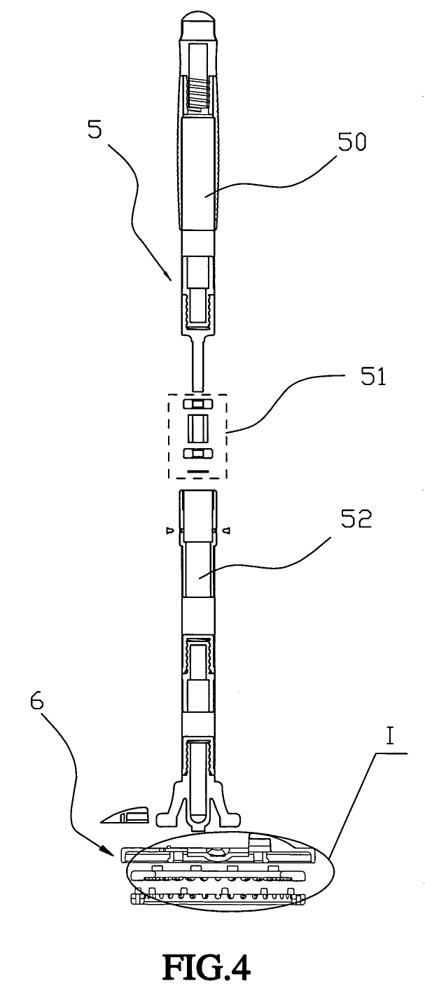

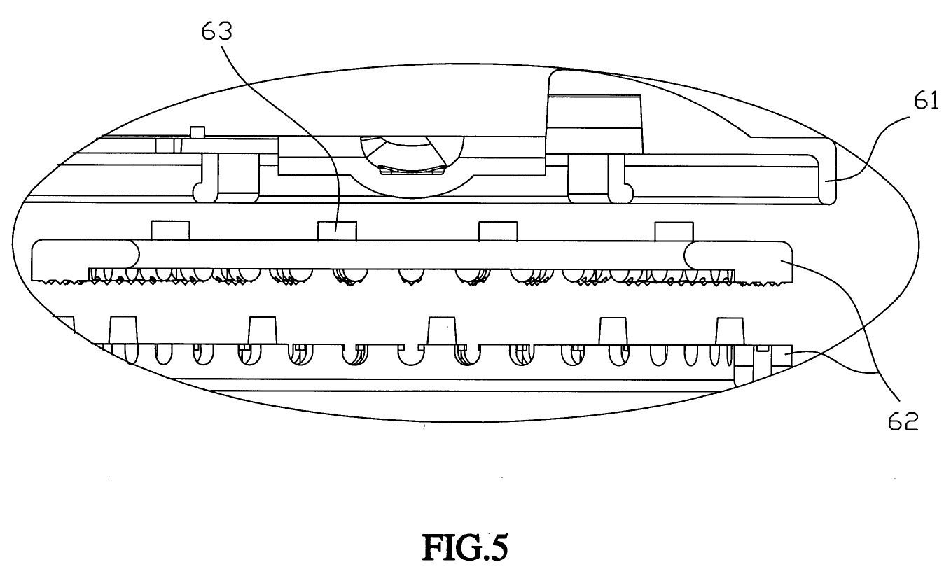

The aforesaid fixing means comprises a plurality of retaining blocks 21 located on the inside wall of the internal chamber 22 of the dehydrating basket 2. As shown in FIGS. 1˜3, when inserting the mop 5 into the internal chamber 22 of the dehydrating basket 2, the presser plate assembly 6 of the mop 5 is forced into engagement with the retaining blocks 21 of the dehydrating basket 2. The presser plate assembly 6 has retaining grooves (not shown) for engagement with the retaining blocks 21 of the dehydrating basket 2. According to the present preferred embodiment, the mop 5 comprises fibrous web elements (not shown) for the retention of fluids for wet-mopping applications, the aforesaid presser plate ssembly 6 that holds the fibrous web elements, and a handle, which is connected with its bottom end to the presser plate assembly 6. The handle comprises an upper handle element 50, a lower handle element 52, and a bearing 51 connected between the upper handle element 50 and the lower handle element 52 for allowing rotation of the lower handle element 52 relative to the upper handle element 50. The presser plate assembly 6 comprises a presser plate 61, and two fibrous web elements clamping plates 62, as shown in FIGS. 4 and 5. The fibrous web elements are fastened to the two fibrous web elements clamping plates 62. The lower handle element 52 has its bottom end fixedly connected to the top side of the presser plate 61. The fibrous web elements clamping plates 62 are fixedly fastened together to hold the fibrous web elements therebetween, and then detachably connected to the presser plate 61 by a detachable connection structure, which comprises a plurality of first fastening devices, for example, fixed hook members 63 located on the top side of the upper fibrous web elements clamping plates 62, and a plurality of second fastening devices, for example, spring-supported hook members located on the bottom side of the presser plate 61 for hooking the first fastening devices 63. Further, the aforesaid power source can be a rechargeable battery pack. Further, a power adapter cable is provided for obtaining the necessary working voltage for the motor drive 4 from city power supply. By means of the power adapter cable, the rechargeable battery pack can be conveniently charged with city power supply.

The mop dehydrating apparatus is operated subject to the following operation steps:

1. Insert the mophead, i.e., the fibrous web elements and presser plate ssembly 6 of the mop 5 into the dehydrating basket 2 to force the presser plate assembly 6 of the mop 5 into engagement with the retaining blocks 21 of the dehydrating basket 2;

2. Hold the upper handle element 50 of the handle of the mop 5 with one hand, keeping the handle of the mop 5 in vertial;

3. Step one foot on the foot pedal switch 3 to switch on the motor drive 4, causing the motor drive 4 to rotate the dehydrating basket 2 via the gear 41 and the transmission shaft 42; and

4. During rotation of the dehydrating basket 2, the lower handle element 52 of the mop 5 and the presser plate assembly 6 of the mop 5 are rotated with the dehydrating basket 2 relative to the upper handle element 50, thereby causing water to be expelled out of the fibrous web elements of the mophead of the mop 5 subject to the effect of centrifugal force.

Further, as stated above, the necessary working voltage for the motor drive 4 can be obtained from the equipped rechargeable battery pack, or city power supply through a power adapter cable

In conclusion, the invention provides a mop dehydrating apparatus, which has advantages and features as follows:

1. The user can hold down the fibrous web elements of the mophead of the mop 5 with one leg and then pull of the handle of the mop 5 vertically upwards with the hands to separate the presser plate 61 of the presser plate assembly 6 and the handle from the fibrous web elements clamping plates 62 and the fibrous web elements.

2. During installation, attach the presser plate 61 of the presser plate assembly 6 to the top side of the fibrous web elements clamping plates 62 on the floor and then impart a downward presser to the presser plate 61 against the fibrous web elements clamping plates 62 with one leg, thus the presser plate 61 and the fibrous web elements clamping plates 62 are fastened together.

3. The user needs not to touch dirty water with the hands when drying the mophead of the mop 5. Simply by means of stepping one leg on the foot pedal switch 3 after insertion of the mop 5 into the dehydrating basket 2, water is expelled out of the mophead of the mop 5.

4. The user can dry the mophead conveniently within a short period of time while keeping the floor dry and clean.

5. With the equipped power adapter cable, the rechargeable battery pack can be charged conveniently when desired.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A mop dehydrating apparatus, comprising:
a water tub said water tub comprising an internal chamber; and
a dehydrating basket horizontally rotatably mounted in the internal chamber of said water tub, said dehydrating basket comprising an internal chamber and fixing means for fixing a mop to the internal chamber of said dehydrating basket;
wherein said water tub comprises a motor drive mounted in the internal chamber thereof and electrically connected to power source means for rotating said dehydrating basket, a transmission means coupled between said motor drive and said dehydrating basket for enabling said motor drive to rotate said dehydrating basket, and switch means mounted in an outside recess thereof and operable to switch on/off said motor drive.

2. The mop dehydrating apparatus as claimed in claim 1, wherein said transmission means comprises a transmission gear meshed with said motor drive for rotation by said motor drive, and a transmission shaft fixedly connected between said transmission gear and said dehydrating basket for allowing rotation of said dehydrating basket in said water tub by said motor drive.

3. The mop dehydrating apparatus as claimed in claim 2, wherein said switch means is a foot pedal switch having a bottom lug supported on spring means in said outside recess.

4. The mop dehydrating apparatus as claimed in claim 1, 2 or 3, wherein said fixing means comprises a plurality of retaining blocks provided inside the internal chamber of said dehydrating basket for engaging respective retaining grooves on a presser plate assembly of said mop.

5. The mop dehydrating apparatus as claimed in claim 1, 2 or 3, wherein said mop comprises fibrous web elements for the retention of fluids for wet-mopping applications, a presser plate assembly that holds said fibrous web elements, and a handle connected to said presser plate assembly.

6. The mop dehydrating apparatus as claimed in claim 5, wherein said handle comprises an upper handle element, a lower handle element, and a bearing connected between said upper handle element and said lower handle element for allowing rotation of said lower handle element relative to said upper handle element.

7. The mop dehydrating apparatus as claimed in claim 5, wherein said presser plate assembly comprises a presser plate, and two fibrous web elements clamping plates, said fibrous web elements clamping plates being fastened together and detachably connected to said presser plate by a detachable connection structure to secure said fibrous web elements, said presser plate being fixedly connected to a lower handle element of said handle.

8. The mop dehydrating apparatus as claimed in claim 7, wherein said detachable connection structure comprises a plurality of first fastening devices located on a top side of said fibrous web elements clamping plates, and a plurality of second fastening devices located on a bottom side of said presser plate for engaging said first fastening devices.

9. The mop dehydrating apparatus as claimed in claim 1, 2 or 3, wherein said power source means comprises a rechargeable battery, and a power adapter cable electrically connectable to city power supply.
